(19) United States
(12) Patent Application Publication
(10) Pub. No.: US 2011/0011819 A1
(43) Pub. Date: Jan. 20, 2011

(54) MODULAR FEEDING BOTTLE

(76) Inventor: Kathy Gayi Lee, San Diego, CA (US)

Correspondence Address: Goodwin Procter LLP;Attn: Patent Administrator, 135 Commonwealth Drive, Menlo Park, CA, 94025-1105, US

(21) Appl. No.: 12/864,920

(22) PCT Filed: Jan. 30, 2009
(86) PCT No.: PCT/US09/32735

§ 371 Date: Sep. 30, 2010

Related U.S. Application Data
(60) Provisional application No. 61/025,390, filed on Feb. 1, 2008.

(51) Int. Cl. A61J 9/04; B65D 83/00

(52) U.S. Cl. 215/11.5; 215/388; 215/387

(57) ABSTRACT

A modular feeding system assembled as an upright, hands-free feeding bottle or a traditional nurser bottle (which requires holding the bottle during feeding). The pressure equalization features of such an assembled device may have health benefits to the user or care giver. The other complementary, modular parts can be used to convert the bottle (or other suitable container) into a sippy cup or a sports bottle. The parts offer versatility in bottle feeding to the user, whether it is an infant, toddler, adult, elderly person or animal.

### BACKGROUND OF THE INVENTION

1. Technical Field

The present invention relates to a hands-free drinking/feeding system designed to accommodate various feeding needs, ranging from a baby, toddler, adult, elderly person or even to pets (animals).

2. Description of Related Art

Otitis media with effusion is one of the most common problems of infancy and early childhood and is responsible for substantial morbidity and expense. (Stool S E, Berg A O, Berman S, et al. Otitis media with effusion in young children. Clinical practice guideline. AHCPR Publication no 94-0622 1994) There are many reasons why children are more likely to suffer from otitis media than adults. In addition to children having more trouble fighting infections with a still-developing immune system, another reason has to do with the child's eustachian tube being shorter and more horizontal than in the adult. The orientation of an infant's Eustachian tube may allow backflow of fluid (e.g., milk from traditional bottle feeding) when lying in a supine position. This tube equalizes middle ear air pressure in response to air pressure changes in the environment. However, a eustachian tube that is blocked by swelling of its lining or plugged with mucus from a cold or for some other reason cannot open to ventilate the middle ear. The lack of ventilation may allow fluid from the tissue that lines the middle ear to accumulate. If the eustachian tube remains plugged, the fluid cannot drain and begins to collect in the normally air-filled middle ear and become prone to bacterial infection and ear pain. This process is similar to a sinus infection that requires proper drainage in an upright position.

Studies have shown that breast feeding has a protective effect against middle ear disease. Infants exclusively breast-fed tend to have substantially fewer acute otitis media episodes, compared to infants who are not breast-fed. Breast-feeding is believed to protect the child from occurrence of otitis media during the first year of life as a result of immunological factors provided through the breast milk, especially secretory IgA, which has antibody activity against respiratory tract viruses and bacteria. However, a breast-feeding infant also uses a different assortment of muscles and generates less negative pressure in the middle ear than does a bottle-fed infant, especially if the bottle-fed child goes to bed with a bottle. Bottle-fed children may aspirate fluids in the middle ear with the higher intraoral pressures, and if they are horizontal in bed while they are taking their bottle, it could predispose them to reflux, as well. (Update on Otitis Media by Cecilia Tran, MD July 2005)

Avoiding supine bottle feeding (“bottle propping”) has been postulated to reduce the incidence of AOM in infancy. (American Academy of Pediatrics Subcommittee on Management of Acute Otitis Media. Diagnosis and management of acute otitis media. Pediatrics. 2004 May; 113(5):1451-65. Review.) When using conventional feeding bottles, negative pressure is generated in the oral cavity, as well as, in the bottle when fluid is removed by sucking. The negative pressure inside the bottle causes the infant to suck excessively and the intraoral negative pressure may subsequently be transmitted to the middle ear via the eustachian tube. With conventional non-ventilated and under-ventilated bottles a negative pressure can form while the infant sucks and negative intratympanic pressure can be generated. It has been suggested that this sequence of events may lead to secretory otitis and its accompanying consequences. By contrast, it has been demonstrated that a fully ventilated bottle has positive pressure throughout the feeding procedure, which is similar to normal breast-feeding, and negative pressure changes are not recorded in the middle ear. (Brown and Magnusun Int J Pediatr Otorhinolaryngol. 2000 Aug. 11; 54(1):13-20)

In addition, given the recent increase in multiple birth events attributable to both fertility drugs and in vitro techniques, a problem has arisen for those parents who are faced with feeding multiple newborns at regular intervals. As a consequence of the foregoing situation, a need has arisen for a new and improved ergonomically designed baby bottle construction that will simplify the feeding process and substantially reduce the wrist fatigue experienced by parents and caregivers who spend hours a day coping with multiple infant feedings or the feeding of premature infants.

Baby feeding bottles are generally well known, and bottle devices having a flexible liquid flow tube engaged between a nipple and a liquid holding container are likewise known, as is disclosed in U.S. Pat. Nos. 4,898,290; 4,969,564, and 5,749,483. Drawbacks of currently available bottle devices are that they may allow backflow, leaking, siphoning and ingestion of air.

Therefore, there is a need for an improved hands-free feeding system that is more economical to manufacture, universal in application, easier to clean and which exhibits improved air pressure exchange without sacrificing fluid delivery and ease of use.

### BRIEF SUMMARY OF THE INVENTION

The present invention relates generally to baby feeding or nursing bottles, and more specifically to containers (e.g., bottles) with one or more valves effective to allow equalization of pressure between the bottle interior and the environment, and optionally having a flexible tube extending from the bottle to the nipple, to allow the infant to be placed in an upright position while nursing and thus mitigate complications associated with Acute Otitis Media and other problems. Containers may include, or be operably connected with, a reservoir which may be adjacent to a nipple.

Embodiments of the present invention address needs for a hands-free fluid delivery system by providing an improved hands-free feeding system that includes an internal straw/seal adapter with valve to help equalize pressure inside the bottle and/or nipple. Embodiments of the present invention include a nipple retainer that when engaged with the nipple and a flexible straw may have a pipette-like function. In embodiments of the present invention, a hands-free baby bottle may be readily converted to a sippy cup which also includes a valve and which also provides the advantages of pressure equalization and reduces air intake during drinking. This improved hands-free feeding system is capable of effective equalization of gaseous pressure in the bottle with the external environment and provides reduced air intake during feeding both of which help to reduce colic and ear infections. This improved hands-free feeding system is also easier to clean and more economical to manufacture than prior hands-free feeding systems, while providing the advantages of reduced air intake, ease of use, and flexibility of use.

In embodiments having features of the invention, a fluid container or fluid container assembly or system comprising a valve is provided for holding and delivering fluid, wherein said valve includes an inner face, an outer face and a valve portion. The valve portion comprises an aperture having an open configuration and a closed configuration; the aperture is configured to assume an open configuration when gaseous pressure adjacent one face is greater than gaseous pressure adjacent the other face, and is further configured to assume a closed configuration when gaseous pressures adjacent both faces are substantially the same. Thus, embodiments having features of the invention are effective to allow equalization of gaseous pressure across the valve. In preferred embodiments, the fluid container or fluid container assembly or system is configured for use as a baby bottle, a sippy cup, or other bottle or cup. In further preferred embodiments, the fluid container or fluid container assembly or system is configured to be able to be configured for use as either a baby bottle or as a sippy cup.

In one embodiment of the invention, a fluid container comprising a gasket is provided for use in devices for holding and delivering fluid, wherein said gasket has an inner face, an outer face and a valve portion. The valve portion comprising an aperture having an open configuration and a closed configuration and configured to assume an open configuration when gaseous pressure adjacent one face of the gasket is greater than gaseous pressure adjacent the other face of the gasket, and further configured to assume a closed configuration when gaseous pressures adjacent both faces of the gasket are substantially the same. Thus, embodiments having features of the invention are effective to allow equalization of gaseous pressure across said gasket.

In another embodiment of the invention, a fluid container comprising a straw adapter is provided. The straw adaptor is for use in devices for holding and delivering fluid, wherein said straw adapter has an elongated cylindrical portion connected with a gasket portion and connection between said elongated cylindrical portion and said gasket portion being a substantially fluid-tight connection. The gasket portion has an inner face, an outer face and a valve portion, wherein said valve portion comprises an aperture having an open configuration and a closed configuration and configured to assume said open configuration when gaseous pressure adjacent one face of the gasket portion is greater than gaseous pressure adjacent the other face of the gasket portion, and further configured to assume said closed configuration when gaseous pressures adjacent both faces of the gasket portion are substantially the same. Thus, in such embodiments, a fluid container comprising a straw adapter is effective to allow equalization of gaseous pressure across said gasket portion.

In another embodiment of the invention, a nipple retainer is provided for use in devices for holding and delivering fluid. The nipple retainer comprises a cylindrical chamber with sealed base configured with a centered spout and an open top portion. The top portion is configured to accommodate a nipple; wherein the interface between the nipple and the nipple retainer form a substantially fluid-tight connection. Such a top portion may be connected directly to a container for holding fluid or may be connected via a tube or other conduit (preferably a flexible conduit) to a container for holding fluid. When configured with a nipple, the interior of the nipple retainer can serve as a reservoir for fluid. With the addition of a straw, these three components yield a pipette-like feature.

A modular feeding system is provided comprising elements configured to be assembled into a baby bottle, a hands-free baby bottle, a sippy cup, or combinations thereof. The modular feeding system provides many advantages. For example, it is believed that embodiments of modular feeding system are easy to use, easy to clean, more comfortable to use, provide reduced negative pressure in a user's middle ear, and provide other advantages. In addition, a hands-free baby bottle having features of the invention allows the user a choice of feeding with or without having to hold the bottle. A hands-free upright feeding device is also helpful for infants with motor defects/disabilities that cannot hold a bottle.

### BRIEF DESCRIPTION OF THE DRAWINGS

FIG. 1 illustrates an embodiment of the new and improved modular feeding system.

FIG. 2A illustrates a preferred embodiment of the modular feeding system converted to a sippy cup.

FIG. 2B illustrates am alternative embodiment of the modular feeding system converted to a sippy cup.

FIG. 3A illustrates the components included in one embodiment of a modular feeding system kit.

FIG. 3B illustrates the components included in alternate embodiment of a modular feeding system kit.

FIG. 4 illustrates an embodiment of a sippy cup handle.

FIG. 5 illustrates alternative embodiments of the modular feeding system in different configurations.

FIG. 6A illustrates a outside drawing of the nipple retainer.

FIG. 6B illustrates a cut away drawing of the nipple retainer.

FIG. 6C illustrates a ½ cross section drawing of the nipple retainer.

FIG. 7 illustrates the modular feeding system utilizing alternative embodiments of the bottle cap ring and nipple retainer.

FIG. 8 illustrates an internal straw/seal, in accordance with one embodiment of the invention.

FIG. 9 illustrates an embodiment of an internal straw/seal for use with a sippy cup configuration.

### DETAILED DESCRIPTION OF THE EXEMPLARY EMBODIMENTS OF THE INVENTION

As used herein, a hands-free baby bottle is a container for holding fluid, such as milk (breast milk or formula) and for delivering it to a user, such as a baby, where the user need not hold the container in the user's hands (although the user may do so if desired). For example, a hands-free baby bottle may include a nipple operably connected to a fluid container (e.g., a bottle) by means of a tube or other conduit, so that the nipple may be disposed at a distance, or at an angle, or both, with respect to the position and orientation of the fluid container to which it is operably connected. The tube or other conduit is effective to provide a continuous fluid pathway between the nipple and fluid container so that the user may drink the fluid from the container via the nipple and tube or other conduit. Preferably, such a tube or other conduit is flexible.

As used herein, a sippy cup is a fluid container that typically does not include a nipple, but instead has a spout or other orifice for drinking liquid contained within the container. In embodiments, a sippy cup includes a lid with a spout or other orifice configured for use by an infant or child, and configured to aid drinking liquid contained within the container while minimizing the risk of spilling the liquid. A sippy cup may have a handle or handles.

Exemplary embodiments of the invention are described in detail below with reference to the figures wherein like elements are referenced with like numerals throughout. It is understood that the figures are not necessarily drawn to scale but intended to merely illustrate some of the novel aspects, features and processes of the invention.

The modular parts of this bottle are interchangeable and can be converted to aid in feeding of various users. The bottle can be modified and assembled with its complementary parts. The main modular parts of this apparatus can be used to assemble a hands-free feeding bottle (assembly with the external straw) or a traditional nurser bottle (which requires holding the bottle during feeding). The other complementary, modular parts can be used to convert the bottle into a sippy cup or a sports bottle. The modular parts offer versatility in bottle feeding to the user, whether it is an infant, toddler, adult, or elderly person. Table 1 provides a chart listing the modular parts of the apparatus and identifies suitable materials to be used in manufacturing. It will be understood that the listings of the following chart are not exhaustive, and that other materials may be suitable and may be used in the manufacture of parts, devices, assemblies, and systems having features of the invention.

TABLE 1

| Bottle Part | | Suitable Materials |
|---|---|---|
| 1) | nipple cap | Polycarbonate |
| | | Biodegradable wheat resin |
| 2) | nipple | Latex |
| | | Silicone |
| | | FDA approved, food grade |
| | | PVC material |
| 3) | nipple retainer (for | Polycarbonate |
| | nipple or mouthpiece) | Biodegradable wheat resin |
| 4) | nylon cleaning brush | Nylon bristle and stainless |
| | | steel handle |
| 5) | external straw | PVC |
| | | Food grade silicone |
| | | Polyethylene |
| 6) | internal straw/seal | Polyethylene |
| | | Silicone |
| | | Polypropylene (food grade) |
| | | Viton |
| 7) | bottle cap ring | Polycarbonate |
| | | Biodegradable wheat resin |
| 8) | bottle | Glass |
| | | BPA-free polypropylene |
| | | Biodegradable wheat resin |
| | | PES (polyethersulfone) |
| 9) | mouthpiece (sippy | Latex |
| | cup) | Silicone |
| 10) | bottle handle adapter | Polycarbonate |
| | (sippy cup handle) | Biodegradable wheat resin |

In general, the size and material of the component parts of the modular feeding system can be designed to accommodate various feeding needs, ranging from a baby, toddler, adult, elderly person or even to pets (animals). The modular feeding system structures may incorporate any type of FDA-approved plastics, rubber or glass, such as those listed in Table 1, or other suitable materials. It is understood that any materials, or combinations thereof, that are suitable for infant handling and meet FDA standards are contemplated to be within the scope of the present invention. The nipple retainer and internal straw/seal (or alternatively referred to as the internal straw adapter) can be manufactured in different sizes to fit most nipples and bottles on the market (the bottles sold on the market come in various proprietary sizes; and sizes of nipple and bottle neck diameter may vary by ⅛-inch or so). The current dimensions of preferred embodiments have been designed to fit the narrow neck bottles (1-inch neck diameter; about 6-inch height), or alternatively the wide neck bottles (2-inch neck diameter; about 4-inch height). In embodiments, the nipple diameter may be about 1-inch to 2-inches in diameter. The foregoing specification sets forth the invention in its preferred, practical forms as a baby bottle or sippy cup but the size and structure of the components shown are capable of modification within a range of equivalents without departing from the invention. In embodiments, dimensions may be larger to accommodate older children, adults or animals.

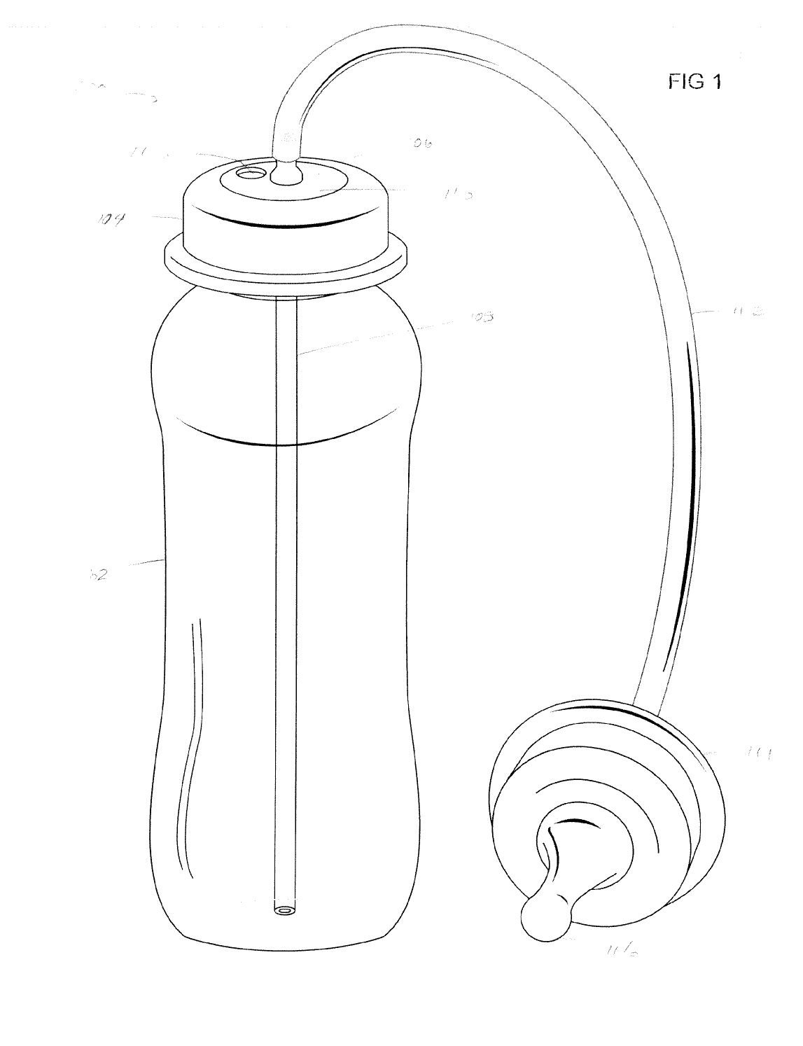

With reference to the drawings, and in particular to FIG. 1, an embodiment of the new and improved modular feeding system generally designated by the reference numeral 100 will be described. The modular feeding system 100 includes a bottle 102 with standard bottle cap ring 104, an internal straw adapter 106 having an elongated cylindrical portion 108 connected with a gasket portion 110, an external flexible straw 112, a nipple retainer 114, and a nipple 116. The internal straw adapter 106 is placed within the bottle 102 and secured to the bottle's cap ring 104. The bottle cap ring is designed to be compatible with most commercially-available bottles. The elongated cylindrical portion 108 comprises an internal straw to draw fluid from the base of the bottle 102 to help reduce air intake within the bottle, during feeding. The connection between the elongated cylindrical portion 108 and the gasket portion 110 is a substantially fluid-tight connection. To facilitate air pressure exchange within the bottle 102, the gasket portion 110 is designed with a valve portion 118, which incorporates an aperture. The outer rim of the gasket 110 can have ridges or perforations to allow for air flow (ventilation) through the cap ring threading on 104 and the neck threading on 102 when the gasket 110 is covered by the cap ring 104. The top section of the internal straw adapter 106 can be attached to the bottom end of a longer, flexible, external straw 112. The bottle's exterior, longer straw allows for hands-free feeding. The top end of the external straw 112 is then connected to a nipple retainer 114. This nipple retainer 114 is sealed at the base but has a centered spout that the external straw 112 can attach to. The interior of this retainer 114 can serve as a reservoir for milk as it is drawn from the base of the bottle 102. A silicone nipple 116 (or a mouth piece) is to be inserted into the top portion of the nipple retainer 114 for feeding. This synthetic nipple can have varying perforation designs to resemble the flow of milk in the lactiferous ducts exiting a human nipple. This apparatus enables bottle feeding in an upright position without having to hold the bottle 102.

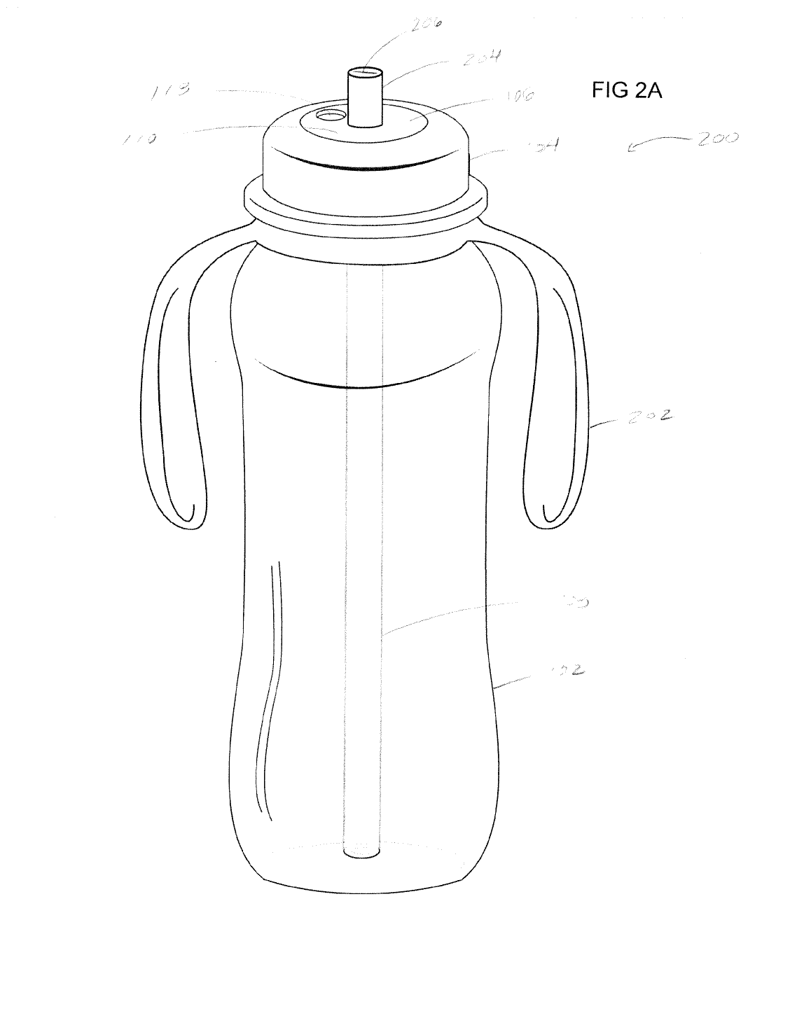

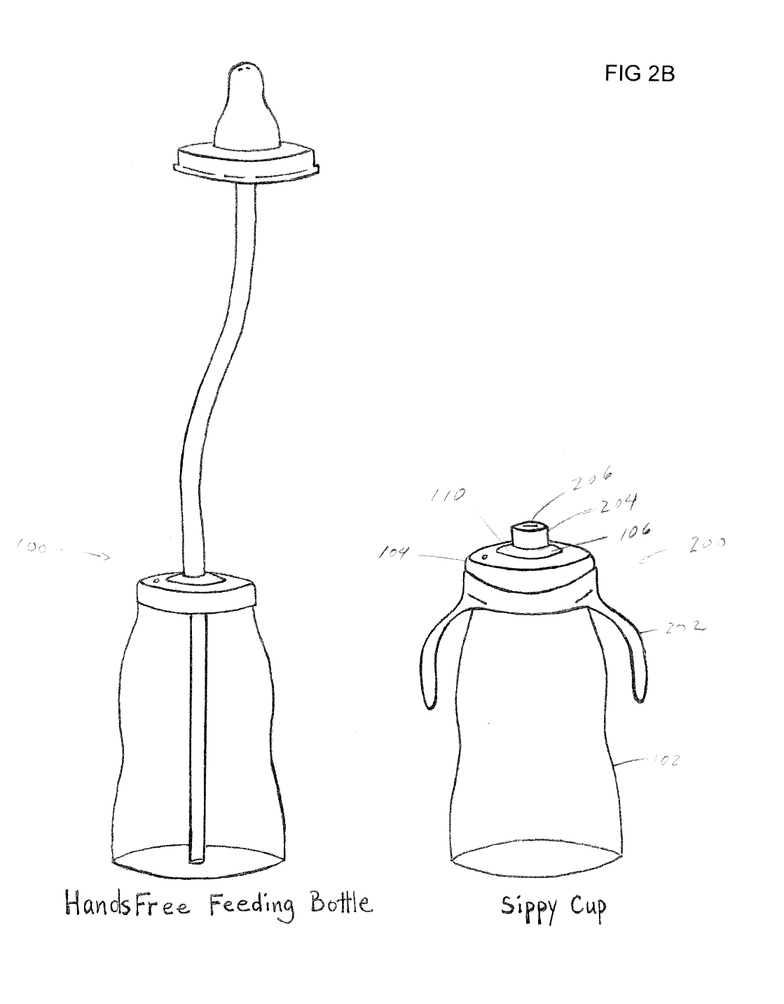

In another embodiment of the invention, as depicted in FIG. 2A, the modular feeding system 100 can be converted to a sippy cup 200 by appending the bottle 102 with a handle adapter 202 that allows holding the bottle with handles and a mouthpiece 204 connected to the internal straw adapter 106 and secured to the bottle 102 with the bottle's cap ring 104. In both FIG. 1 and FIG. 2A, valve 118 is shown, and is useful to allow passage of air to equalize air pressure across gasket 110 and between reservoir or bottle 102 and the external environment. In preferred embodiments of the sippy cup, the nipple may be replaced with a fluid control valve 206. Certain embodiments of the fluid control valve may utilize a bite valve which incorporates a means for dispensing or controlling the flow of liquid through a single slit at the point of egress of the liquid controlled or dispensed thereby. Deformation of the valve body by biting thereupon opens the slit to a limited extent, the walls defining the slit being forced apart essentially in a single plane to create a liquid dispensing orifice. When no deforming forces are applied to the valve body, the orifice is relatively restricted and liquid flow impeded to a considerable extent. FIG. 2B depicts an alternative embodiment of the modular feeding system 100 converted to a sippy cup 200. In this embodiment, the internal straw adapter 106 is configured without an elongated cylindrical portion (or straw) 108 extending into the bottle 102.

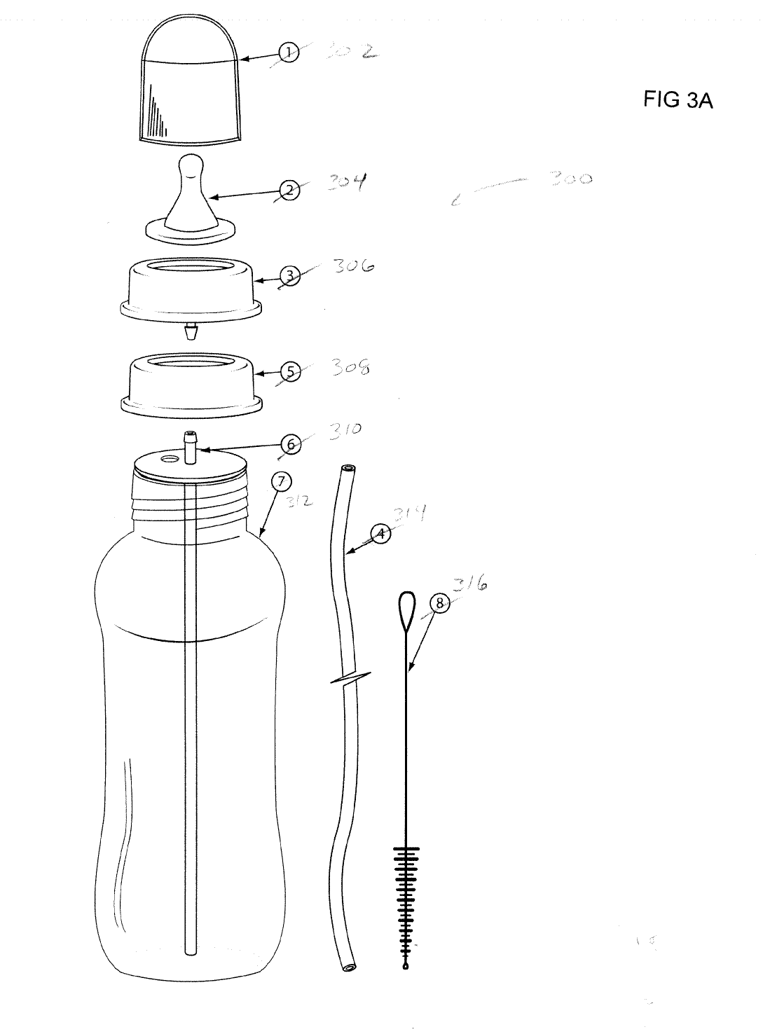

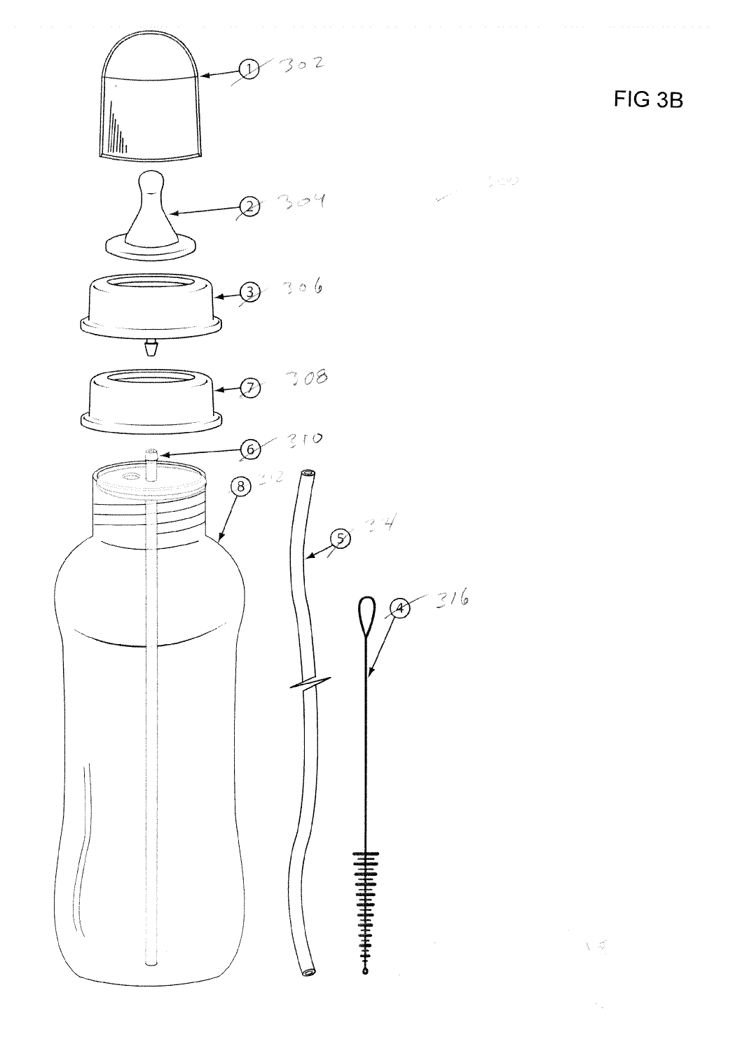

FIG. 3 illustrates the components included in one embodiment of a modular feeding system kit 300. One embodiment of a kit comprising bottle assembly parts for use in a modular feeding system include a nipple cap 302, a nipple 304, a nipple retainer 306, a bottle cap ring 308, an internal straw/seal 310, a bottle 312, an external straw 314 and a nylon cleaning brush 316. In alternative embodiments, the kit may also include instructions for assembling the modular feeding system. In embodiments of the modular feeding system adapted for use as a sippy cup, the kit may also include a handle adapter, a sippy cup straw/seal and/or a suitable mouthpiece adapter. FIG. 3B depicts an alternative embodiment of the modular feeding system kit 300. In this embodiment, the internal straw/seal 310 fits within the neck of the bottle 312, optionally having outer rim that rests on top of the bottle opening and forming a seal when secured to the bottle's cap ring 308.

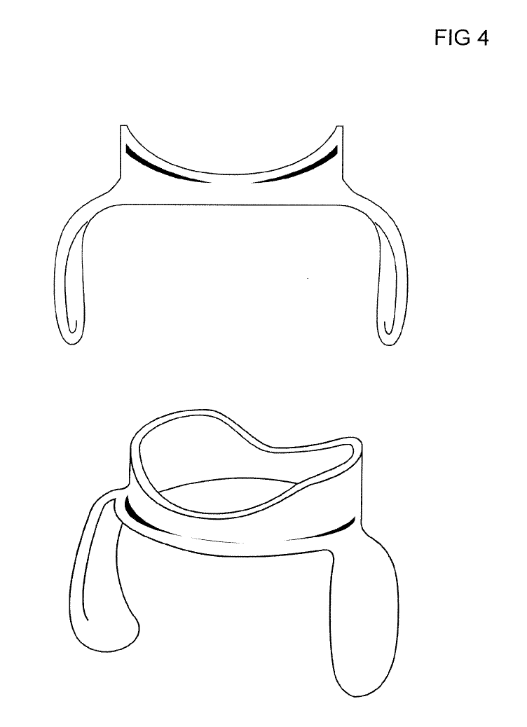

FIG. 4 illustrates an embodiment of a sippy cup handle.

In FIG. 5, alternative embodiments of the modular feeding system are depicted in different configurations.

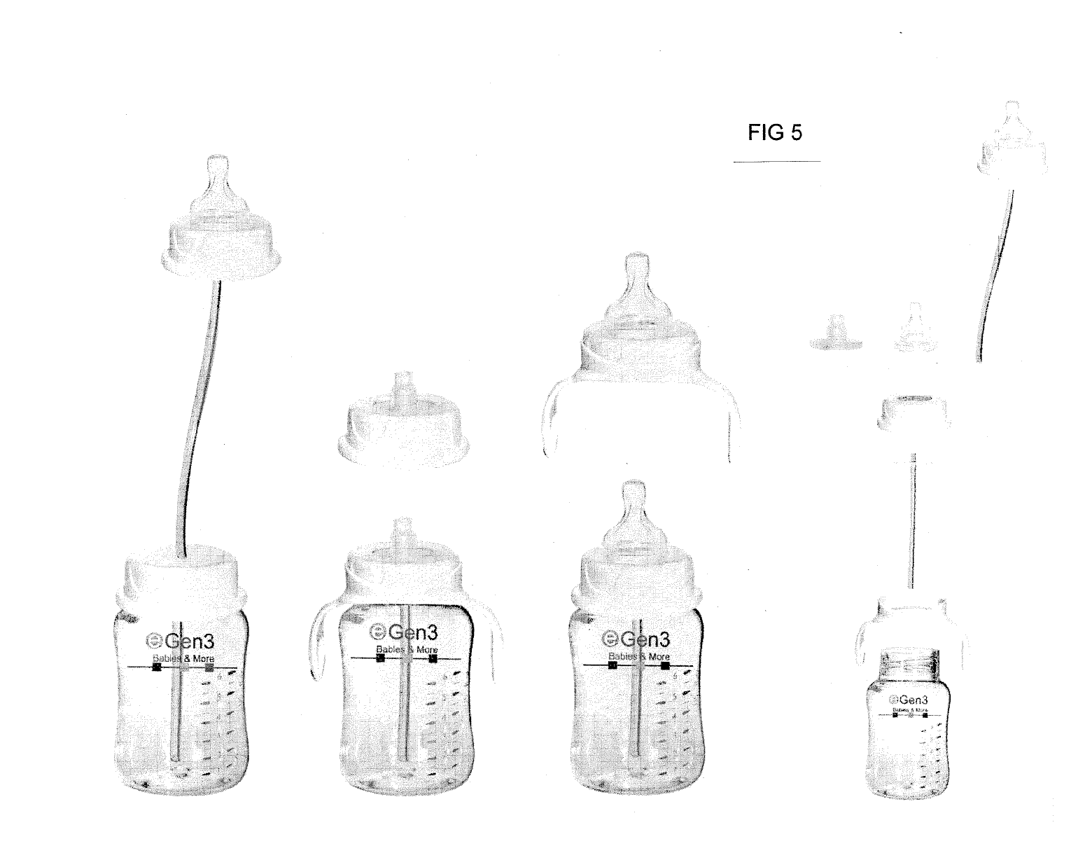

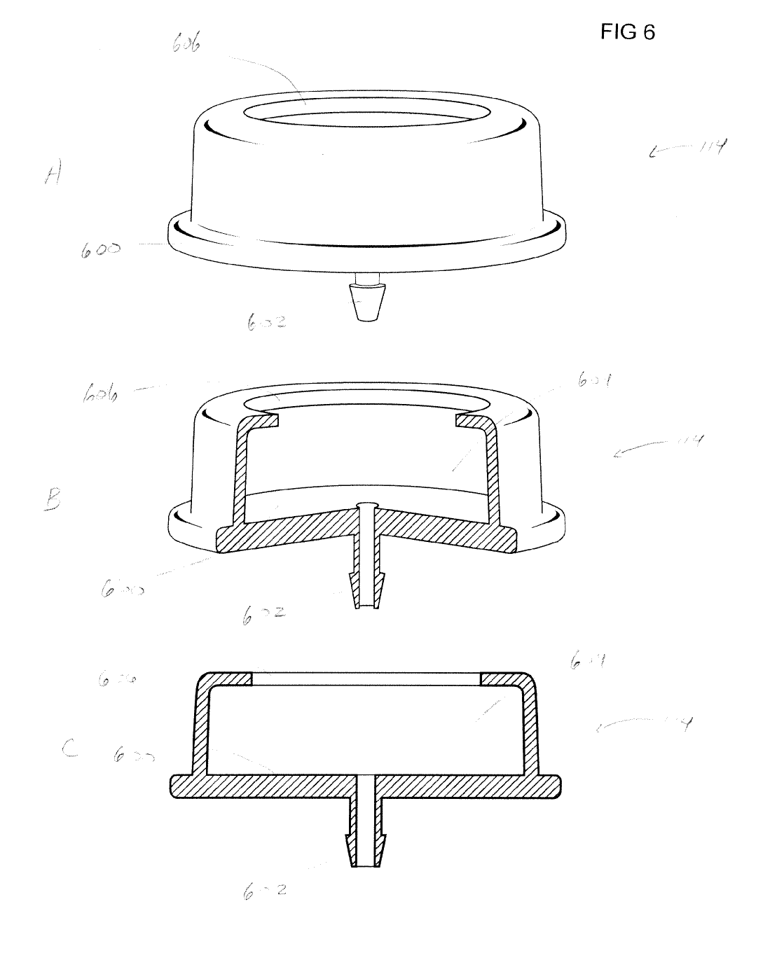

FIG. 6A depicts a side view of the nipple retainer 114 of FIG. 1. This nipple retainer 114 is sealed at the base 600 but has a centered spout 602 that the external straw can attach to. FIGS. 6B and 6C illustrate a cut away and a 1/2 cross section of the nipple retainer, respectively. The interior of this retainer 114 can serve as a reservoir 604 for milk as it is drawn from the bottle. A silicone nipple (or a mouth piece) is to be inserted into the top portion 606 of the nipple retainer 114 for feeding. This unit is for housing the nipple. It has a hard plastic texture. The interior ring diameter can be variable to fit most standard nipples (e.g., the ring diameter can be 1-inch or 2-inch to correspond to most standard nipple's base diameter which in turn corresponds to most standard bottle neck diameter). The spout (located at the base of the nipple retainer) has an almost microscopic barb that secures it to the flexible 12″ external straw. The interface between the nipple and the nipple retainer form a substantially fluid-tight connection; and, when configured together, the space within the nipple retainer enclosed by the nipple can serve as a reservoir for fluid. In one aspect of the present invention the nipple, when connected with the nipple retainer, serves as a built-in primer by acting in a similar fashion to a pipette bulb. In this capacity, squeezing the nipple and releasing causes the reservoir within the nipple retainer to become full with liquid drawn from the bottle and prevents the baby from ingesting air. In another embodiment of the invention, the nipple retainer is designed with a circular groove around the interior surface of the top portion adjacent to the opening for housing the nipple. This serves to accommodate the raised circular rim around the base of some nipple designs and increase effectiveness of the substantially fluid-tight connection between the nipple retainer and the nipple.

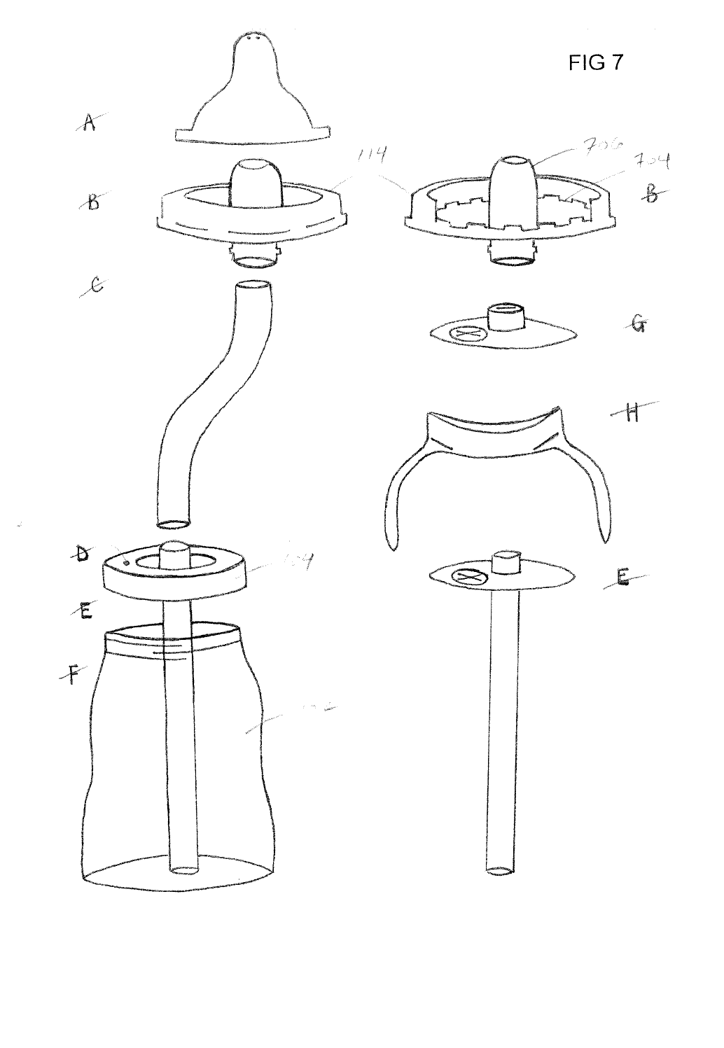

In FIG. 7, the modular feeding system is depicted utilizing alternative embodiments of the bottle cap ring and nipple retainer. In alternative embodiments of the present invention, the top portion of the bottle's cap ring 104 may optionally have a small hole 702 to help reduce air pressure within the bottle 102. The nipple retainer 114, having a sealed base with a centered spout that an external straw can attach to, may optionally have an interior base of the nipple retainer 114 with a ridged design 704 to enhance ventilation and to reduce a vacuum effect within its cavity. The base of the silicone nipple, mouth piece and internal straw adapter may have slits on the disk-like surface that are to be aligned with a hole in the bottle cap ring 702 when assembled, to help reduce air pressure within the bottle. In certain embodiments, the nipple retainer 114 may have a central, hollow protrusion 706 at the top that extends down to the spout at the base. When present, this top part of the retainer serves to help regulate and retain fluid while simulating the feel of a human female breast during breastfeeding.

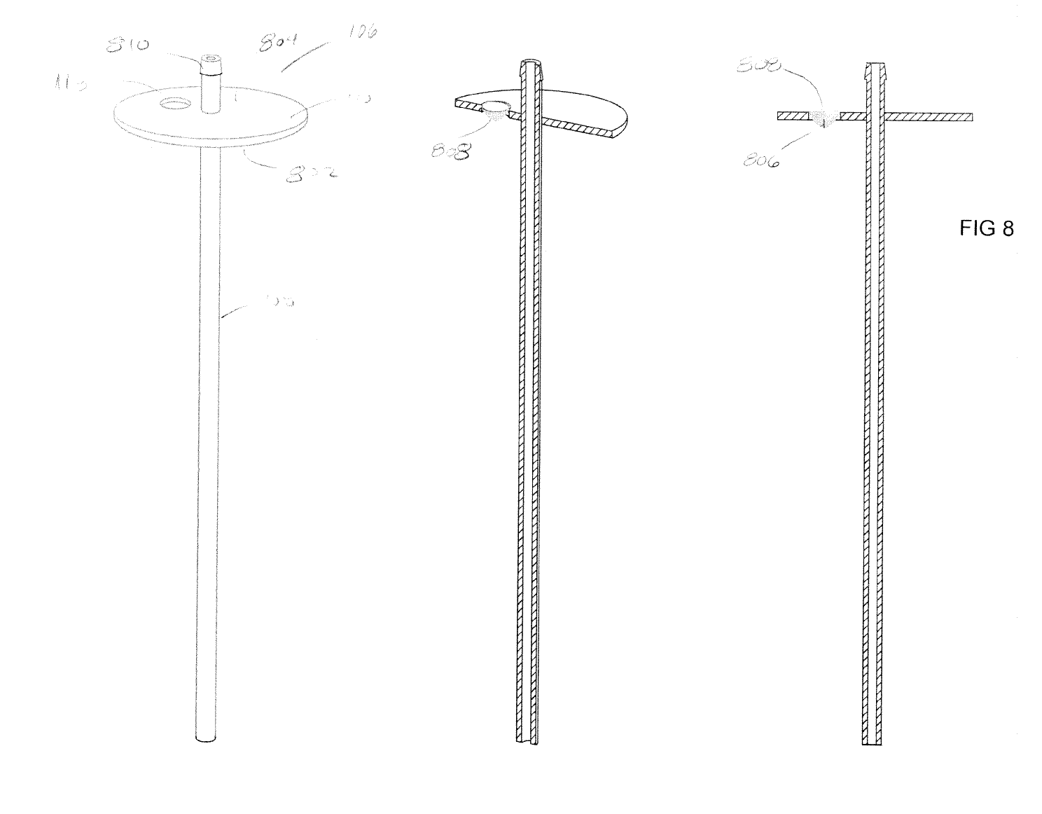

FIG. 8 depicts an isolated internal straw/seal adapter 106 of the modular feeding system 100 from FIG. 1. This is the internal straw/seal that goes inside the bottle while the seal sits on top of the bottle's neck rim. The internal straw/seal adapter 106 has an elongated cylindrical portion (or straw) 108 connected with a gasket portion (or seal) 110. The connection between the elongated cylindrical portion 108 and gasket portion 110 is a substantially fluid-tight connection. The gasket portion 110 has an inner face 802, an outer face 804 and a valve portion 118. In one embodiment, the valve 118 has an aperture comprised of a slit 806 in the middle of a concave, bowl-like structure 808. A valve portion 118 may have one slit, or two slits, or more slits, effective to provide an aperture when the leaflets adjacent the slit or slits are not touching each other, and effective to occlude the aperture when the leaflets adjacent the slit or slits are touching each other. A slit, or slits, of a valve portion 118 may be along a diameter, or other line of symmetry of a valve effective to provide substantially symmetrical leaflets of a valve. In embodiments, a slit or slits, of a valve portion 118 may lie along a chord, or otherwise be along a line or lines that is not a line of symmetry of a valve, effective to provide one or more asymmetrical leaflets of a valve. A valve portion 118 is effective to substantially block fluid flow when closed (e.g., when leaflets adjacent the slit 806 or slits are touching each other). A valve portion 118 is effective to allow air flow through the valve portion 118 when open (e.g., when one or more of the leaflets adjacent the slit or slits are not touching another leaflet), and preferably without allowing substantial fluid leakage. In preferred embodiments, a valve portion 118 is a one-way valve. This valve, which may preferably be a one-way valve, provides ventilation and may prevent liquid from spilling out of the bottle while letting air into and/or out of the bottle to equalize pressure. In certain embodiments, a valve may have a concave slit, which is believed to provide improved valve tension and to be effective to prevent spillage of liquid from the bottle. The valve portion 118 is configured to assume an open configuration when gaseous pressure adjacent one face of the gasket portion 110 is greater than the gaseous pressure adjacent the other face of the gasket portion 110, and configured to assume a closed configuration when gaseous pressures adjacent both faces of the gasket portion 110 are substantially the same. Thus, effectively allowing equalization of gaseous pressure across said gasket portion 110. The top opening has an almost microscopic barb 810 that secures to the flexible external straw. The flexible external straw may be about 1 or 2 inches long to about 24-inches long, and may be, for example, about 12-inches long. The gasket portion 110 is disk-shaped and manufactured as a contiguous, molded piece from a soft, malleable material (e.g., silicone). In preferred embodiments, the gasket portion can be 1-inch or 2-inches in diameter; with a thickness of about 1 mm to about 10 mm, and may be about 2 mm thick. In preferred embodiments, the elongated cylindrical portion 108 is about 6-inches long. However, variable lengths can be manufactured to fit other bottles. In certain embodiments, the base of the elongated cylindrical portion near the bottom of the bottle has an angled cross section to prevent suction at the bottom of the bottle preventing liquid from being drawn into the straw. The texture of the elongated cylindrical portion 108 may be the same as the gasket portion 110 or can be a harder texture than the gasket portion 110. In one embodiment of the internal straw/seal adaptor, the elongated cylindrical portion and gasket portion are fused together at their point of connection without threads. This reduces the number of parts and facilitates cleaning.

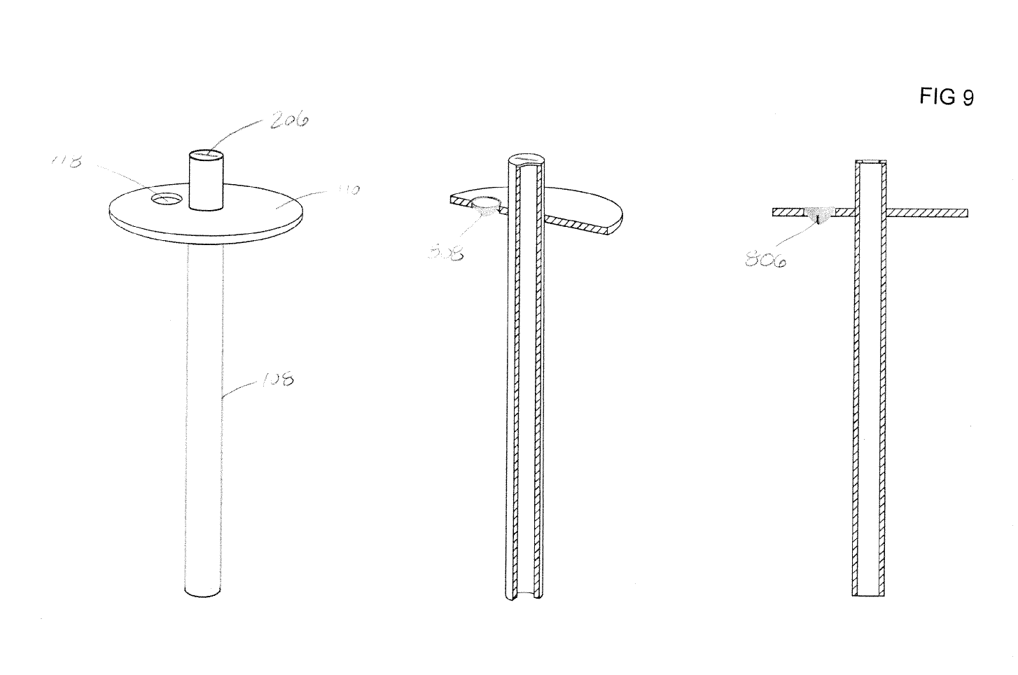

FIG. 9 illustrates an embodiment of an internal straw/seal for use with a sippy cup configuration. In this embodiment, the top opening has been modified by removing the barb 810 for securing the flexible external straw and replacing with a fluid control valve 206. The fluid control valve may be configured to be substantially closed in one configuration, and open in another configuration (e.g. when a child's teeth compress the sides of the fluid control valve, the passage opens and allows fluid to flow).

In alternative embodiments of the valve portion, the shape of the indented ellipsoid area could be oval, square, triangular, star-shaped, or irregular. In addition to the concave ellipsoid cross-section depicted in FIG. 8 other shapes or cross-sections or structures may also work. At least one aperture is required for the structure to act as a valve, however, various embodiments may utilize one, two or multiple slits, and may be arranged in a variety of patters (e.g. cross-shaped or asymmetric leaflets). In preferred embodiments, the size of the valve can be about ¼-inch, but can range from about 5 mm to about 25 mm). Although a one-way valve is preferred, a two-way valve could also be incorporated to allow equalization of gaseous pressure.

Various exemplary embodiments of the invention have been described above. However, it is understood that these various embodiments are exemplary only and should not limit the scope of the invention as recited in the claims below. Various modifications of the exemplary embodiments described above can be implemented by those of ordinary skill in the art, without undue experimentation. For example, although the invention has been described in the context of modular infant feeding systems, it would be apparent to one of ordinary skill in the art that the invention can be applied to feeding/drinking systems comprising different types of materials or design modifications for various feeding needs, ranging from a baby, toddler, adult, elderly person or even to pets (animals). These various modifications are contemplated to be within the spirit and scope of the invention as set forth in the claims below.

What is claimed is:

1. A gasket for use in devices for holding and delivering fluid, said gasket having an inner face, an outer face and a valve portion, said valve portion comprising an aperture having an open configuration and a closed configuration, said valve portion being configured to assume said open configuration when gaseous pressure adjacent one face of the gasket is greater than gaseous pressure adjacent the other face of the gasket, and configured to assume said closed configuration when gaseous pressures adjacent both faces of the gasket are substantially the same, effective to allow equalization of gaseous pressure across said gasket.

2. A straw adapter for use in devices for holding and delivering fluid, said straw adapter having an elongated cylindrical portion connected with a gasket portion, said connection between said elongated cylindrical portion and said gasket portion being a substantially fluid-tight connection, said gasket portion having an inner face, an outer face and a valve portion, said valve portion comprising an aperture having an open configuration and a closed configuration, said valve portion being configured to assume said open configuration when gaseous pressure adjacent one face of the gasket portion is greater than gaseous pressure adjacent the other face of the gasket portion, and configured to assume said closed configuration when gaseous pressures adjacent both faces of the gasket portion are substantially the same, effective to allow equalization of gaseous pressure across said gasket portion.

3. A nipple retainer for use in devices for holding and delivering fluid, said nipple retainer comprising a cylindrical chamber with sealed base configured with a centered spout and an open top portion, said top portion being configured to accommodate a nipple; wherein the interface between the nipple and the nipple retainer form a substantially fluid-tight connection; and wherein configured with a nipple, the interior of said nipple retainer can serve as a reservoir for fluid.

4. A fluid container comprising the gasket of claim 1.

5. A fluid container comprising the straw adapter of claim 2.

6. A fluid container comprising the nipple retainer of claim 3.

7. An assembly comprising a fluid container, a nipple, a nipple retainer, and a gasket of claim 1, wherein said nipple retainer is configured to engage with said gasket in a fluid-tight configuration, and said gasket is configured to engage with said fluid container in a fluid-tight configuration.

8. An assembly comprising a fluid container, a nipple, a nipple retainer and a straw adapter of claim 2, wherein said nipple retainer is configured to engage with said straw adapter in a fluid-tight configuration, and said straw adapter is configured to engage with said fluid container in a fluid-tight configuration.

9. A fluid delivery system comprising a fluid container, a nipple, a nipple retainer, an external straw connected to said nipple retainer, and a straw adapter having an elongated cylindrical portion connected with a gasket portion, said straw adapter being configured to engage said external straw in a substantially fluid-tight configuration effective to provide a continuous passage for fluid flow within said elongated cylindrical portion and said external straw effective to provide fluid to said nipple retainer, wherein said connection between said elongated cylindrical portion and said gasket portion comprises a substantially fluid-tight connection, said gasket portion having an inner face, an outer face and a valve portion, said valve portion comprising an aperture having an open configuration and a closed configuration, said valve portion being configured to assume said open configuration when gaseous pressure adjacent one face of the gasket portion is greater than gaseous pressure adjacent the other face of the gasket portion, and configured to assume said closed configuration when gaseous pressures adjacent both faces of the gasket portion are substantially the same, effective to allow equalization of gaseous pressure across said gasket portion.

10. A kit comprising instructions, a fluid container, a nipple retainer, and a gasket of claim 1, wherein said nipple retainer is configured to engage with said gasket in a fluid-tight configuration, and said gasket is configured to engage with said fluid container in a fluid-tight configuration, and said instructions describe the assembly and use of said fluid container, nipple, nipple retainer and gasket.

11. A kit comprising instructions, a fluid container, a nipple retainer, and a straw adapter of claim 2, wherein said nipple is configured to engage with said straw adapter in a fluid-tight configuration, and said straw adapter is configured to engage with said fluid container in a fluid-tight configuration, and said instructions describe the assembly and use of said fluid container, nipple, nipple retainer and straw adapter.

12. A kit of either claim 10 or claim 11, further comprising an external straw.

13. The kit of either claim 10 or claim 11, further comprising a handle portion configured for use in a sippy cup configuration.

14. The kit of claim 13, wherein said instructions describe the assembly and use of the kit components in a first configuration as a baby bottle and in a second configuration as a sippy cup
